(19) United States
(12) Patent Application Publication
(10) Pub. No.: US 2014/0240237 A1
(43) Pub. Date: Aug. 28, 2014

(54) CHARACTER INPUT METHOD BASED ON SIZE ADJUSTMENT OF PREDICTED INPUT KEY AND RELATED ELECTRONIC DEVICE

(71) Applicant: Samsung Electronics Co., Ltd., Gyeonggi-do (KR)

(72) Inventors: Sungwook PARK, Gyeonggi-do (KR); Sehwan PARK, Gyeonggi-do (KR); Jaeyong LEE, Seoul (KR)

(73) Assignee: Samsung Electronics Co., Ltd., Gyeonggi-do (KR)

(21) Appl. No.: 14/190,741

(22) Filed: Feb. 26, 2014

(30) Foreign Application Priority Data
Feb. 26, 2013 (KR) 10-2013-0020645

(51) Int. Cl. G06F 3/023; G06F 3/0488

(52) U.S. Cl. CPC G06F 3/0237; G06F 3/04886
USPC 345/168

(57) ABSTRACT

An electronic device having an input unit and a display unit which displays an input screen corresponding to the input unit. When a user's input is received through the input unit, the device predicts the next input, based on the received input, and then adjusts a size of a key region for receiving the next input in the input unit.

### PRIORITY

This application claims priority under 35 U.S.C. §119(a) to a Korean Patent Application filed in the Korean Intellectual Property Office on Feb. 26, 2013 and assigned Serial No. 10-2013-0020645, the entire disclosure of which is incorporated herein by reference.

### BACKGROUND

1. Field of the Invention

The present invention generally relates to character input technology for electronic devices, and more particularly, to a method for predicting a next input based on a current input and providing a size-adjusted input key based on such a prediction, and to an electronic device implementing the method.

2. Description of the Related Art

With mobile communication technologies becoming more advanced, electronic devices generally have decreased in size to enhance portability. Most of these devices have an input unit for receiving a touch-based input from a user together with a display unit. For enhanced portability and a reduction in power consumption, both the display unit and the input unit tend to be limited in size.

Generally, electronic devices now have a touch screen in which the display unit and the input unit are formed together. Using a touch screen, the display unit can display virtual keys corresponding to and acting as keys of the input unit.

However, due to a limited size of the device, unintended input errors often happen using small-sized keys. If fewer keys are used in the input unit in order to improve input accuracy, an input action is required several times.

Therefore, there is a need for enhancing input accuracy and also simplifying the input process.

### SUMMARY

The present invention has been made to address at least the problems and disadvantages described above, and to provide at least the advantages described below.

Accordingly, an aspect of the present invention provides a character input method that allows a more accurate and rapid input. Another aspect of the present invention provides a method for predicting a next input based on a current input and providing a size-adjusted input key based on such a prediction. Additionally, an aspect of the present invention provides an electronic device implementing the method.

According to an aspect of the present invention, a method for inputting a character in an electronic device having an input unit is provided. The method includes displaying an input screen corresponding to the input unit on a display unit; receiving a user's input through the input unit; and based on the received input, adjusting a size of a key region for receiving a next input in the input unit.

According to another aspect of the present invention, an electronic device is provided which includes an input unit configured to receive a user's touch input; a display unit configured to display an input screen corresponding to the input unit; and a control unit configured to, based on the received input, adjust a size of a key region for receiving a next input in the input unit.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating an electronic device in accordance with an embodiment of the present invention;

FIG. 2 is a flowchart illustrating a character input method based on a size adjustment of a predicted input key in accordance with an embodiment of the present invention;

FIG. 3 is a flowchart illustrating a character input method based on a size adjustment of a predicted input key in accordance with another embodiment of the present invention;

FIG. 4 is a screenshot illustrating a display unit of an electronic device in accordance with an embodiment of the present invention;

FIGS. 5A and 5B are screenshots illustrating a size adjustment of a predicted input key in accordance with an embodiment of the present invention;

FIGS. 6A and 6B are screenshots illustrating a size adjustment of a predicted input key in accordance with another embodiment of the present invention;

FIGS. 7A and 7B are screenshots illustrating a size adjustment of a predicted input key in accordance with still another embodiment of the present invention; and

FIGS. 8A and 8B are screenshots illustrating a size adjustment of a predicted input key in accordance with yet another embodiment of the present invention.

### DETAILED DESCRIPTION OF EMBODIMENTS OF THE PRESENT INVENTION

The following description with reference to the accompanying drawings is provided to assist in a comprehensive understanding of various embodiments of the present invention as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to their dictionary meanings, but are merely used to enable a clear and consistent understanding of the present invention. Accordingly, it should be apparent to those skilled in the art that the following description of various embodiments of the present invention is provided for illustration purposes only and not for the purpose of limiting the present invention as defined by the appended claims and their equivalents.

It is to be understood that the singular forms “a,” “an,” and “the” include plural referents unless the context clearly dictates otherwise. Thus, for example, reference to “an input key” includes reference to one or more of such input keys.

Herein, the term “electronic device” refers to any kind of device that has a touch screen. Specifically, an electronic device may include a mobile phone, a smart phone, a tablet PC, a video phone, an e-book reader, a desktop PC, a notebook PC, a laptop PC, a netbook computer, a Personal Digital Assistant (PDA), a Portable Multimedia Player (PMP), a media player (e.g., an MP3 player), a mobile medical device, a digital camera, a digital broadcasting terminal, a portable game console, an electronic dictionary, an electronic scheduler, a wearable device, home appliance, and any other equivalents.

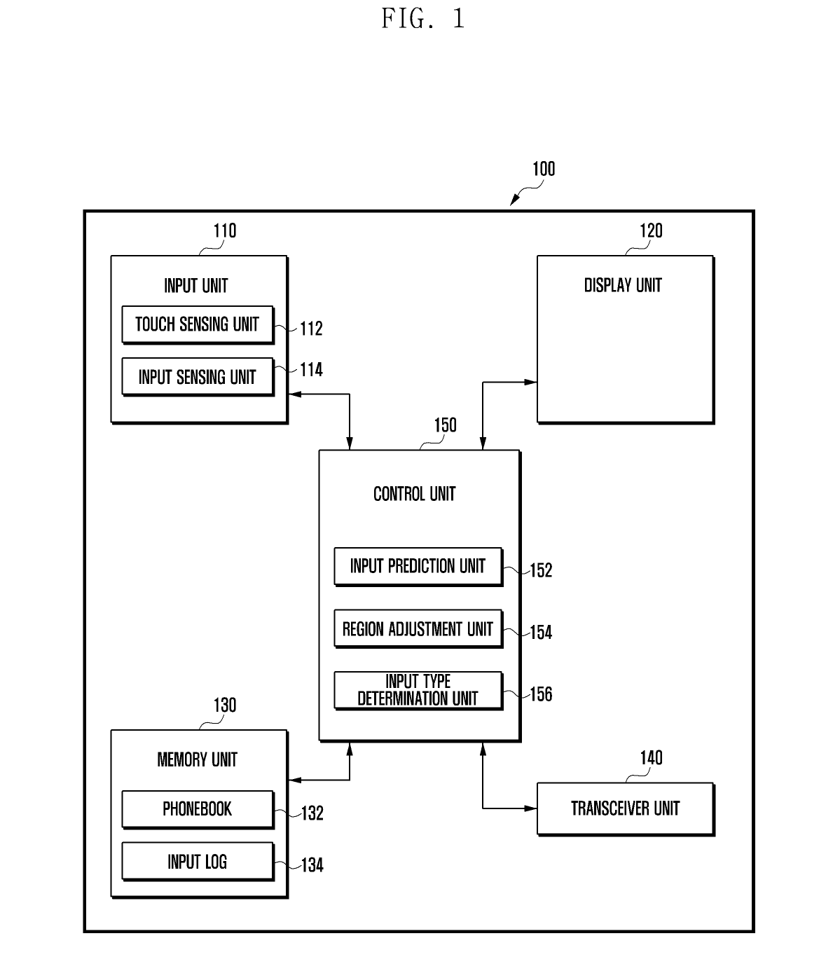

FIG. 1 is a block diagram illustrating an electronic device in accordance with an embodiment of the present invention.

Referring to FIG. 1, the device 100 includes an input unit 110 configured to receive a user input, a display unit 120 configured to display a screen associated with the operation of the device 100, a memory unit 130 configured to store data received or transmitted by the device 100, a transceiver unit 140 configured to transmit or receive data to or from any entity that allows wired or wireless access of the device 100, and a control unit 150 configured to control the operation of the device 100.

The input unit 110 may include a touch sensing unit 112 capable of sensing a user's touch input, and an input sensing unit 114 capable of sensing other inputs including a drag gesture or any other types of input. In some embodiments, the touch sensing unit 112 and the input sensing unit 114 may be formed of the same module.

The display unit 120 displays any information, including a current operating status, to a user. The display unit 120 may be formed of a typical display device such as an LCD (Liquid Crystal Display), OLED (Organic Light Emitted Diode), AMOLED (Active Matrix OLED), a flexible display, or the like.

In some embodiments, the input unit 110 and the display unit 120 may be disposed at corresponding positions. In this case, when a certain region is displayed on the display unit 120, the input unit 110 may receive a user's input through the displayed region on the display unit 120. Specifically, the input unit 110 and the display unit 120 may be realized in the form of a touch screen based on any input technology of a capacitive type, resistive type, infrared type, ultrasonic type, or the like. A plurality of virtual keys may be displayed on the display unit 120, and the input unit 110 may create an input signal in response to a user's input action made on such a virtual key.

In some embodiments, the memory unit 130 includes a phonebook 132 and an input log 134.

The phonebook 132 contains contact information about other users, such as a phone number, a homepage address, a postal address, an email address, and the like. This contact information may be created by a user or received from an external entity. Information that can be recorded in the phonebook 132 is not limited to the above examples and may further include any type information for identifying users.

The input log 134 may contain a record of the user's input received from the input unit 110. As discussed below, based on this input record, the control unit 150 may determine necessary information such as a user's input pattern or frequently entered character string. Further, based on such determined information, the control unit 150 may predict candidates for the next input having a high probability of being entered.

Additionally, the memory unit 130 stores various data transmitted or received through the transceiver unit 140. Based on such data, the control unit 150 may determine character stings having a strong possibility of being entered by a user.

Also, the memory unit 130 may store a dictionary corresponding to a specific language used by a user. Further, the memory unit 130 may store relations between frequently entered words that may be determined using the stored dictionary and any other stored data.

The transceiver unit 140 allows the device 100 to access other entities and then transmit or receive data to or from an accessed entity. Specifically, the transceiver unit 140 may transmit or receive data to or from a base station and also transmit or receive data to or from other entities accessed through WiFi, Bluetooth or any other equivalent communication. The transceiver unit 140 may not be limited to a specific type and may include any kind of apparatus that allows wired or wireless access to any other communication entity.

The control unit 150 may include an input prediction unit 152 for predicting a user's input, a region adjustment unit 154 for adjusting a key region designed to receive a user's input through the input unit 110, and an input type determination unit 156 for determining the type of a user's input.

The input prediction unit 152 predicts the next input to be entered by a user, based on at least one of data entered through the input unit 110, data stored in the memory unit 130, and data received via the transceiver unit 140. Specifically, the input prediction unit 152 predicts candidates for the next input in order to obtain a complete word on the basis of already entered characters. The prediction may be made on the basis of at least one of information stored in the memory unit 130 and data received through the transceiver unit 140. Two or more predicted results may be provided in the order of input possibilities, and information containing predicted results may be displayed on the display unit 120.

In some embodiments, the input prediction unit 152 predicts, based on information received through the transceiver unit 140, at least one of alphabetic letters, numeric digits, punctuation marks, and emoticons to be entered in sequence. Specifically, a communication entity accessed through the transceiver unit 140 may recommend some words having higher probabilities of being entered by a user, based on at least one of data entered by an accessed user or any other user and data stored therein. Recommended words may have priorities in the order of input probabilities, and such recommended results may be transmitted to the device 100. Then the device 100 may predict the next characters to be entered, based on data received through the transceiver unit 140. In some embodiments, the input prediction unit 152 calculates a probability distribution of at least one of alphabetic letters, numeric digits, punctuation marks, and emoticons to be entered, based on a user's input or data received from any communication entity. Then, depending on such a probability distribution, key regions having higher probabilities may be adjusted in sizes.

The region adjustment unit 154 calculates the size of a key region for receiving a user's input through the input unit 110 under the control of the control unit 150, and then adjusts the size of a key region according to calculated results. For example, when a user enters some characters “stu” and then the input prediction unit 152 predicts “f” and “d” as the next characters to be entered, the region adjustment unit 154 may increase the size of input regions corresponding to “f” and “d” on the input unit 110.

The input type determination unit 156 determines a user's intention of input into the input unit 110. In some embodiments, the input type determination unit 156 determines whether a current user input is to search for data stored in the memory unit 130 or to search for data stored in any external communication entity accessed through the transceiver unit 140. For example, in the case of a search for data stored in the phonebook 132, a prediction for the next input may be performed on the basis of much higher probability since a search scope is relatively limited. Thus, in this case, the region adjustment unit 154 may greatly increase the size of a key region.

As discussed above, by adjusting the size of a key region on the basis of a user's input, data stored in the memory unit 130, and/or data received through the transceiver unit 140, the device 100 can reduce a possibility of any unintended input. Additionally, the device 100 can display a size-adjusted key region of the input unit 110 on the display unit 120, thus enhancing the user's convenience.

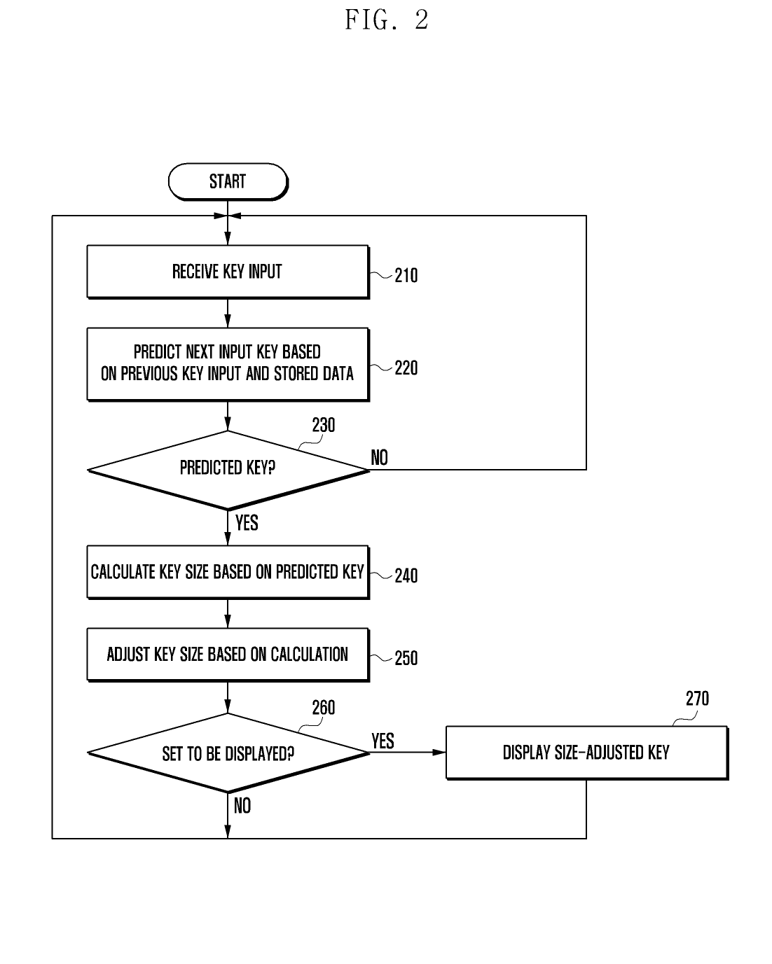

FIG. 2 is a flowchart illustrating a character input method based on a size adjustment of a predicted input key in accordance with an embodiment of the present invention.

Referring to FIG. 2, at step 210, the device receives a key input from a user. In some embodiments, the device receives an input including at least one of alphabetic letters, numeric digits, punctuation marks, and emoticons, through the input unit. In some embodiments, such an input may be performed by means of a touch and/or a drag. In some embodiments, such an input may be performed through a virtual keyboard displayed on the touch screen.

At step 220, the device predicts the next input key, based on at least one of characters entered already and data stored therein. In some embodiments, the device predicts the next input key, further based on data received from any external entity. In some embodiments, one or more input keys may be predicted together with input probabilities thereof and also displayed on the display unit in the order of probabilities.

At step 230, the device determines whether there is any predicted key. If there is no predicted key, the device returns to receive a key input at step 210.

If there is any predicted key, the device calculates at step 240 the size of a key region to be adjusted, based on the predicted key. In some embodiments, if a plurality of keys are predicted and arranged according to input probabilities, size adjustment of key regions may depend on input probabilities.

At step 250, the device adjusts the size of a key region according to calculation results obtained at step 240. In some embodiments, the device may individually and differently adjust respective key regions while the number and arrangement of keys are still maintained. An increased key region may accept an input action of much wider scope. Therefore, this may reduce a possibility of input error.

At step 260, the device determines whether a size-adjusted key is set to be displayed. When there is no setting, the device returns to step 210. When there is a setting, the device displays size-adjusted key regions on the display unit at step 270. In one embodiment, an auxiliary line may be added to an original key region in order to display the size-adjusted key region. In another embodiment, the device may change the size of a virtual key to be displayed on the display unit.

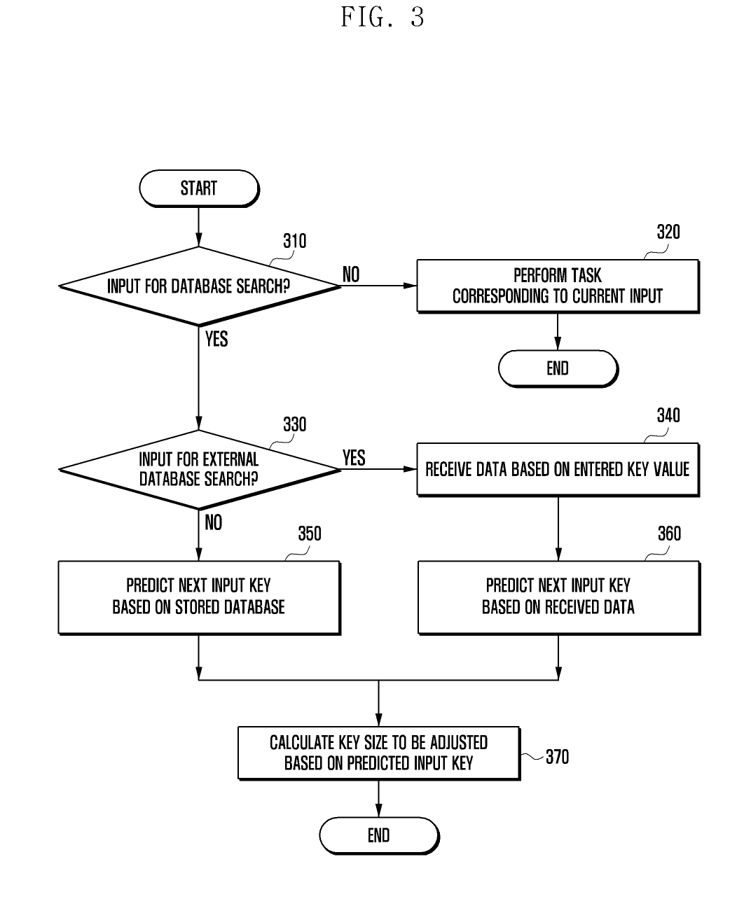

FIG. 3 is a flowchart illustrating a character input method based on a size adjustment of a predicted input key in accordance with another embodiment of the present invention.

Referring to FIG. 3, at step 310, the device determines an input mode when a user's input is received. In one embodiment, the device determines whether a user's input is an input for a database search which may include at least one of a search for data stored in the device and a search for data stored in any external communication entity.

When a user's input is not an input for a database search, the device performs a task corresponding to a current input at step 320. In one embodiment, this task may predict the next input key, based on at least one of characters entered already by a user, character strings entered statistically by other users, and a recent input trend of other users received from other communication entities, and then adjust the size of the predicted input key. In another embodiment, step 320 may comply with operations discussed previously in FIG. 2.

At step 330, the device determines whether a database search is an external database search or an internal database search.

When the search is an external database search, the device receives data from any external communication entity at step 340, based on an entered key value. The received data may include a prediction of the next input based on information stored in the external database.

When the search is an internal database search, the device predicts the next input key at step 350, based on data stored in the memory unit thereof.

In some embodiments, the device receives at step 350 a key input to search the memory unit for a phonebook. When the search is a phonebook search, since the range of data stored in a phonebook is not relatively extensive, a prediction of the next input key based on data stored in a phonebook may become easier.

At step 360, the device predicts the next input key, based on data received from any external communication entity.

At step 370, the device adjusts a key size of the input unit, based on predicted results obtained at step 350 or step 360. In some embodiments, although a key size is adjusted, the number and arrangement of keys displayed on the display unit may not be changed. Since one or more input keys having higher input probabilities are increased in size, a user's input action can be made easier and more accurate.

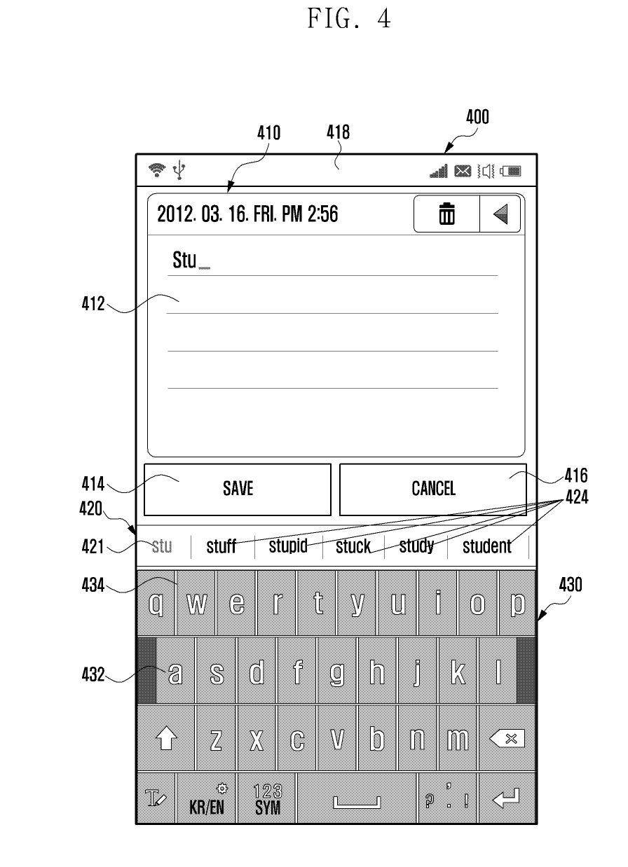

FIG. 4 is a screenshot illustrating a display unit of an electronic device in accordance with an embodiment of the present invention.

Referring to FIG. 4, the display unit 400 of the device includes a status indicator region 418, an input content display region 410, a predicted word display region 420, and an input key display region 430. In some embodiments, the display unit 400 may be formed of a touch screen that allows a touch-based input into each region of the display unit 400. In some embodiments, the display unit 400 may display a save key 414 and a cancel key 416, each of which may perform a particular function assigned thereto in response to a touch input thereon.

The input content display region 410 displays characters entered by a user through a touch input received on the input key display region 430. In some embodiments, an input character display unit 412 displays entered characters such as “Stu” shown in FIG. 4. In some embodiments, the input content display region 410 may also display data received from any external communication entity.

The predicted word display region 420 displays an input word 421 entered by a user, and one or more predicted words 424 predicted as the next input based on the input word 421. When any predicted word 424 is touched, the device selects the touched word as the next input and displays the selected word on the input character display unit 412. In some embodiments, the predicted words 424 may be arranged in the order of input probabilities, for example, from the left. In an illustrated example, “stuff” has the highest input probability, and “stupid” has the second highest input probability.

The input key display region 430 displays a plurality of virtual input keys arranged in the form of a keyboard having, for example, but not limited to, a “qwerty” array. The input key display region 430 may have key regions 432 for receiving a touch input, and boundary regions 434 located between adjacent key regions 432. When the boundary region 434 receives a touch input, the device may regard it as an input on the closest key region 432 or no input.

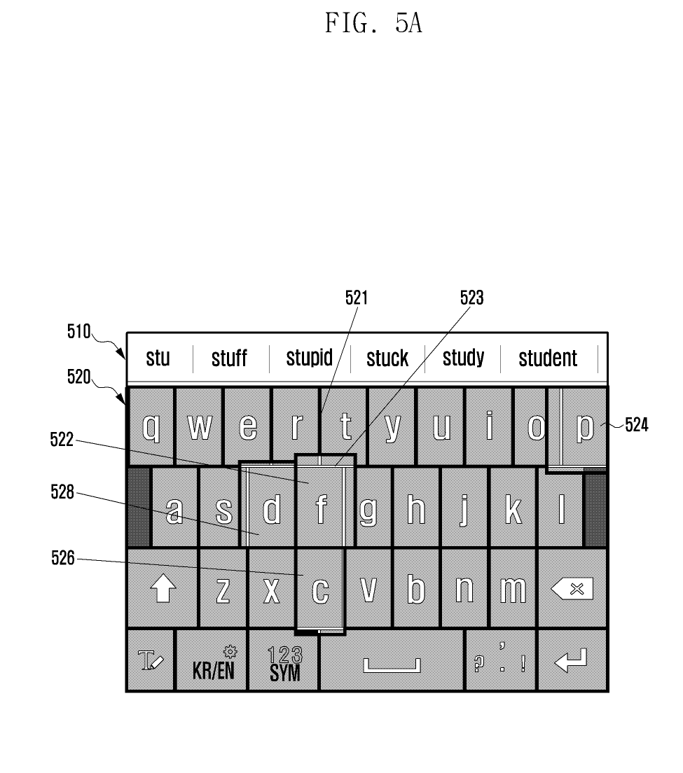

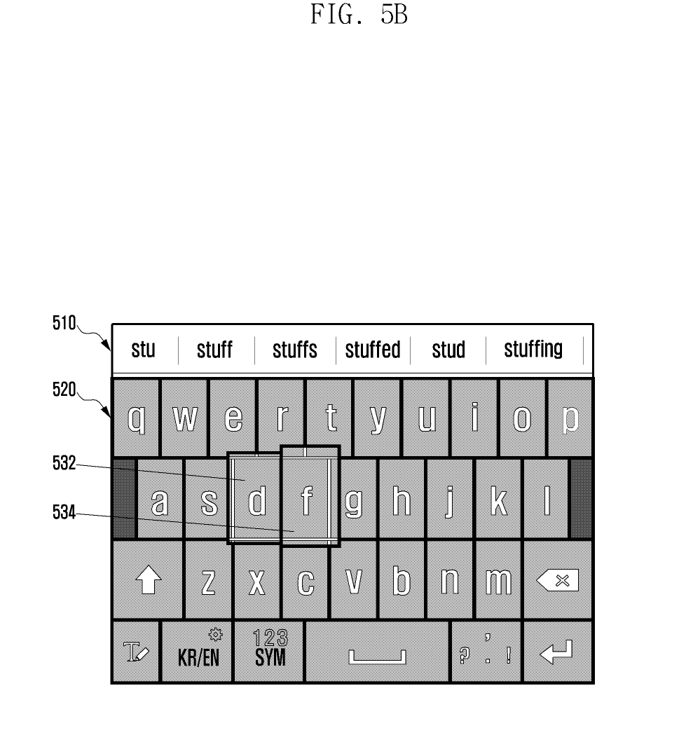

FIGS. 5A and 5B are screenshots illustrating a size adjustment of a predicted input key in accordance with an embodiment of the present invention.

Referring to FIGS. 5A and 5B, the display unit has a predicted word display region 510 and an input key display region 520.

The predicted word display region 510 displays one or more predicted words having higher input probabilities, based on input words entered previously in the device.

The input key display region 520 displays a plurality of virtual input keys arranged in the form of keyboard having, for example, but not limited to, a “qwerty” array. The display unit may be formed of a touch screen. Therefore, when any region is touched, the device determines that an input assigned to the touched region is received.

In one embodiment, an input boundary line 521 may not be displayed on the display unit. In another embodiment, depending on a user's setting, the input boundary line 521 may be displayed as an auxiliary line on the display unit. The input boundary line 521 indicates a virtual line used for identifying each key region assigned to the input unit of the device.

A display boundary line 523 may be displayed to identify each key region displayed on the input key display region 520. The display boundary line 523 may have a predefined width. When the display boundary line 523 receives a touch input, the device may regard it as an input on the closest key region or no input.

In an illustrated example, a user has entered characters “stu”, and then the control unit of the device determines that the next input word is “stuff”, “stupid”, “stuck”, “study”, or “student”.

Therefore, in view of determination results, characters having higher input possibilities are “f”, “p”, “c”, and “d”. In some embodiments, a word arranged on the left may have a strong input possibility.

Based on such prediction results, the control unit of the device adjusts key regions assigned to the input unit. In an illustrated example, the device enlarges an “f” region 522, a “p” region 524, a “c” region 526, and a “d” region 528. Enlarged sizes may be different according to input probabilities. In the above example, the “f” region 522 may have the highest input probability and thus have the greatest size.

FIG. 5B shows the next situation in which a user further enters a character “f” in a situation shown in FIG. 5A. Considering words displayed on the predicted word display region 510, the next input character is predicted as “f” or “d”. In this case, the device enlarges an “f” region 534 and a “d” region 532. In one embodiment, the “f” region 534 having a higher input probability has a greater size than the “d” region 532. Therefore, even though a user touches a spot adjacent to an original “f” key, the device can receive an “f” input. As discussed, by adjusting a key region on the basis of a user's input, input errors can be prevented.

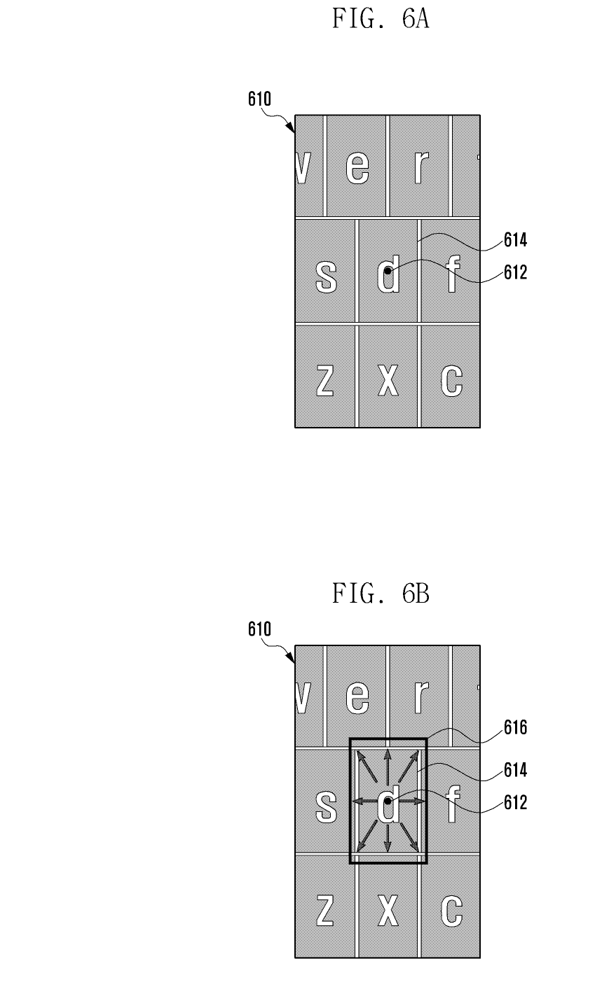

FIGS. 6A and 6B are screenshots illustrating a size adjustment of a predicted input key in accordance with another embodiment of the present invention.

Referring to FIGS. 6A and 6B, a part 610 of the input key display region is shown. A display boundary line 614 encloses each key, e.g., a “d” key as shown, pivoting on a central point 612. When a touch action is detected inside the display boundary line 614 around the “d” key, the device determines that an input “d” is received.

If characters predicted as the next key input have “d”, the device enlarges a region designed to receive an input “d”. Namely, an input boundary line 616 is created around the display boundary line 614. In this case, when a touch action is detected inside the input boundary line 616 around the “d” key, the device determines that an input “d” is received. Although in one embodiment the input boundary line 616 may be symmetrically enlarged from the central point 612, other enlargements may be allowed alternatively.

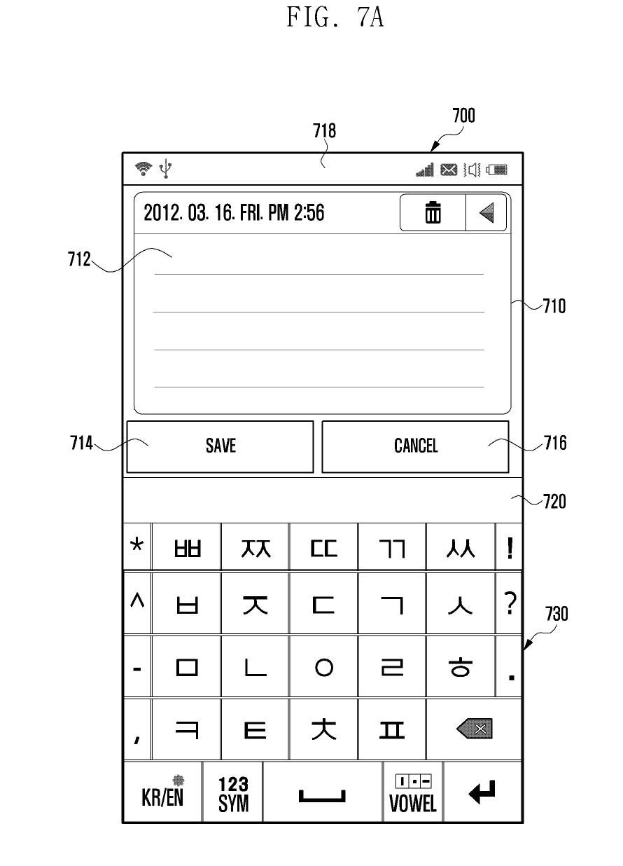

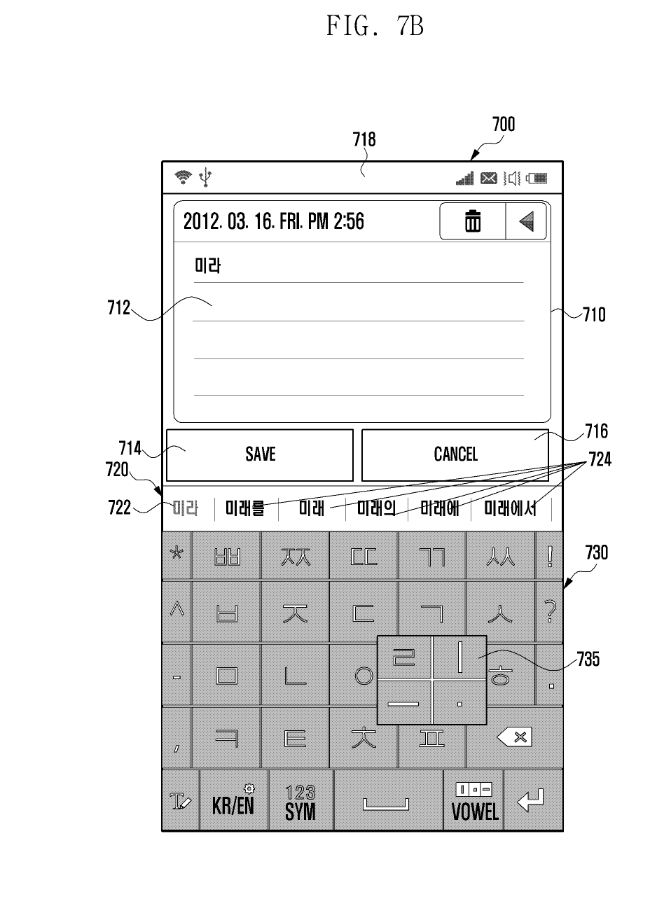

FIGS. 7A and 7B are screenshots illustrating a size adjustment of a predicted input key in accordance with still another embodiment of the present invention.

Referring to FIGS. 7A and 7B, the display unit 700 of the device includes a status indicator region 718, an input content display region 710, a predicted word display region 720, and an input key display region 730.

In some embodiments, the display unit 700 may be formed of a touch screen that allows a touch-based input into each region of the display unit 700. In some embodiments, the display unit 700 may display a save key 714 and a cancel key 716, each of which may perform a particular function assigned thereto in response to a touch input thereon.

The input content display region 710 displays characters entered by a user through a touch input received on the input key display region 730. In some embodiments, an input character display region 712 displays entered characters. In some embodiments, the input content display region 710 may also display data received from any external communication entity.

The predicted word display region 720 displays an input word entered by a user, and one or more predicted words predicted as the next input based on the input word. When any predicted word is touched, the device selects the touched word as the next input and displays the selected word on the input character display region 712. In some embodiments, the predicted words may be arranged in the order of input probabilities, for example, from the left.

The input key display region 730 displays a plurality of virtual input keys arranged in the form of keyboard having, for example, but not limited to, the Korean alphabet array. When each key region in the input key display region 730 receives a touch input, the device may regard it as an input of that key region.

Referring to FIG. 7B, the input character display region 712 displays Korean characters “ [symbol] ” on the basis of a user's input or data received from another communication entity.

Then the predicted word display region 720 displays an input word 722, e.g., “ [symbol] ”, and one or more predicted words 724 such as “ [symbol] ”, “ [symbol] ”, “ [symbol] ”, “ [symbol] ”, and “ [symbol] ”. Some predicted words such as “ [symbol] ” may not be displayed. Such predicted words may be arranged in the order of input probabilities.

The input key display region 730 displays a popup window 735 designed to receive the next key input. In an illustrated example, the popup window 735 may display a Korean consonant “ [symbol] ” (which has been originally displayed) together with three elements “ [symbol] ”, “ [symbol] ” and “.” used to form Korean vowels. This allows an input of Korean vowels as well as an input of Korean consonants arranged in the input key display region 730, thus acting as a so-called “moa key”.

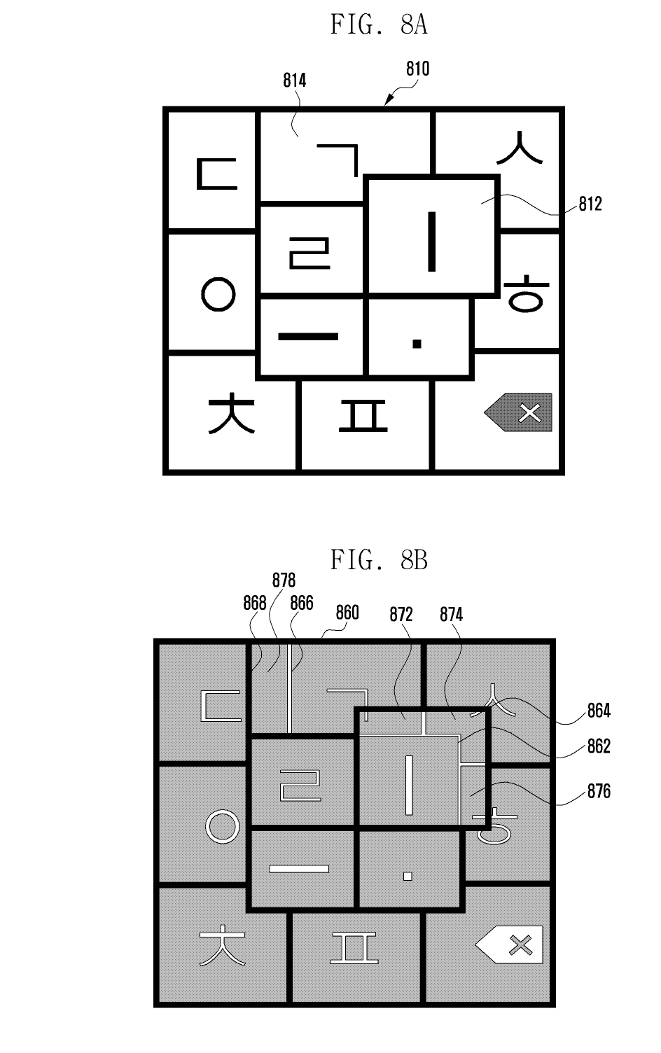

FIGS. 8A and 8B are screenshots illustrating a size adjustment of a predicted input key in accordance with yet another embodiment of the present invention.

Specifically, FIGS. 8A and 8B show a partial region 810 of the input unit around the popup window 735 shown in FIG. 7B. In an illustrated example, when Korean characters “ [symbol] ” are entered, the device predicts, as the next key input, a Korean vowel “ [symbol] ” 812 and a Korean consonant “ [symbol] ” 814. Therefore, the device enlarges input key regions of the input unit as shown in FIG. 8A.

Referring to FIG. 8B, a region of the input unit may or may not be displayed or not on the display unit, depending on embodiments. Boundary lines 860 and 868 are displayed to identify a region assigned to each key of the input unit. When a touch action is detected inside a certain region enclosed by the boundary lines 860 and 868, a specific character assigned to that region is entered as an input. Meanwhile, other boundary lines 862 and 866 are used to identify a key region displayed on the display unit.

In an illustrated example, if a touch input is detected from the boundary line 866 or from an enlarged region 878, the device determines that a Korean consonant “ [symbol] ” is entered as an input. Similarly, if a touch input is detected from the boundary line 862 or from an enlarged region 872, 874 or 876, the device determines that a key element “ [symbol] ” is entered as an input.

As discussed hereinbefore, a size-adjusted key region corresponding to the predicted next key input may accept an input action of much wider scope. Therefore, this may reduce a possibility of input error.

In various embodiments of this disclosure, the device may predict, as the next input, at least one of alphabetic letters (including consonant and vowels), numeric digits, punctuation marks, and emoticons, based on at least one of alphabetic letters, numeric digits, punctuation marks, and emoticons entered by a user or received from other communication entities.

While the present invention has been particularly shown and described with reference to certain embodiments thereof, it will be understood by those skilled in the art that various changes in form and details may be made therein without departing from the spirit and scope of the invention as defined by the appended claims.

What is claimed is:

1. A method for inputting a character in an electronic device having an input unit, the method comprising:
displaying an input screen corresponding to the input unit on a display unit;
receiving a user's input through the input unit; and
based on the received input, adjusting a size of a key region for receiving a next input in the input unit.

2. The method of claim 1, further comprising:
based on the received input, predicting the next input,
wherein adjusting the size of the key region is based on both the received input and the predicted input.

3. The method of claim 2, wherein predicting the next input includes calculating a probability distribution of the next input based on the received input, and
wherein adjusting the size of the key region is based on the probability distribution.

4. The method of claim 2, further comprising:
displaying the predicted next input on the display unit.

5. The method of claim 1, wherein the size of the key region is adjusted while maintaining the number of keys in the input unit.

6. The method of claim 1, further comprising:
displaying an auxiliary line for indicating the size-adjusted key region on the display unit.

7. The method of claim 1, further comprising:
adjusting a key size of the input screen displayed on the display unit in accordance with the size-adjusted key region of the input unit.

8. The method of claim 1, wherein receiving the user's input includes determining whether the user's input is an input for a database search, and wherein adjusting the size of the key region includes adjusting, when the user's input is for the database search, the size of the key region.

9. The method of claim 1, further comprising:
displaying a popup window to allow a further key input in the input screen based on the received input,
wherein adjusting the size of the key region includes adjusting the size of the popup window and the size of a key adjacent to the popup window.

10. The method of claim 1, wherein adjusting the size of the key region includes adjusting the size of the key region in the input unit without a change of the input screen.

11. An electronic device comprising:
an input unit configured to receive a user's touch input;
a display unit configured to display an input screen corresponding to the input unit; and
a control unit configured to, based on the received input, adjust a size of a key region for receiving a next input in the input unit.

12. The electronic device of claim 11, wherein the control unit is further configured to predict the next input, based on the received input, and to adjust the size of the key region, based on both the received input and the predicted input.

13. The electronic device of claim 12, wherein the control unit is further configured to calculate a probability distribution of the next input based on the received input, and to adjust the size of the key region, based on the probability distribution.

14. The electronic device of claim 12, wherein the display unit is further configured to display the predicted next input.

15. The electronic device of claim 11, wherein the control unit is further configured to adjust the size of the key region while maintaining the number of keys in the input unit.

16. The electronic device of claim 11, wherein the display unit is further configured to display an auxiliary line for indicating the size-adjusted key region.

17. The electronic device of claim 11, wherein the display unit is further configured to adjust a key size of the input screen displayed thereon in accordance with the size-adjusted key region of the input unit.

18. The electronic device of claim 11, wherein the control unit is further configured to determine whether the user's input is an input for a database search, and to adjust, when the user's input is for the database search, the size of the key region.

19. The electronic device of claim 11, wherein the display unit is further configured to display a popup window to allow a further key input in the input screen based on the received input, and wherein the control unit is further configured to adjust the size of the popup window and the size of a key adjacent to the popup window.

20. The electronic device of claim 11, wherein the control unit is further configured to adjust the size of the key region in the input unit without a change of the input screen.
